(19) United States
(12) Patent Application Publication
(10) Pub. No.: US 2025/0200904 A1
(43) Pub. Date: Jun. 19, 2025

(54) Occlusion Avoidance of Virtual Objects in an Artificial Reality Environment

(71) Applicant: Meta Platforms Technologies, LLC, Menlo Park, CA (US)

(72) Inventors: Chenxin HONG, New York, NY (US); Philipp SCHOESSLER, Scotts Valley, CA (US); Bruno DE ARAUJO, Toronto (CA); Rahul ARORA, McAllen, TX (US); Justin Ryan REID, San Francisco, CA (US); Dan Kun-yi CHEN, Seattle, WA (US)

(73) Assignee: Meta Platforms Technologies, LLC, Menlo Park, CA (US)

(21) Appl. No.: 18/906,940

(22) Filed: Oct. 4, 2024

Related U.S. Application Data
(60) Provisional application No. 63/610,156, filed on Dec. 14, 2023.

(51) Int. Cl. G06T 19/00; G06F 3/01; G06T 19/20

(52) U.S. Cl. CPC G06T 19/006; G06F 3/012; G06F 3/013; G06T 19/20; G06T 2219/2004

(57) ABSTRACT

Aspects of the present disclosure relate to automatic repositioning of virtual objects, in an augmented or mixed reality environment, to avoid occlusion of certain physical objects or views in the real-world environment. Conventionally, on a head-worn artificial reality system, head-leashed virtual objects simply follow where the head is pointed. Some implementations can detect regions in the field-of-view of the user that should not be occluded, such as faces of other people, media content, a particular activity being performed, and/or where the user's gaze has lingered, and reposition virtual objects to avoid these areas. Alternatively or additionally, some implementations can detect movement of the user in the real-world environment and trigger minimization, repositioning, and/or degradation of virtual objects to lessen obstructions in the user's viewpoint and conserve resources. After the user slows or stops moving, the virtual object can revert to its full form.

### CROSS-REFERENCE TO RELATED APPLICATIONS

This application claims priority to U.S. Patent Application No. 63/610,156, titled “Occlusion Avoidance of Virtual Objects in an Artificial Reality Environment,” filed Dec. 14, 2023, which is herein incorporated by reference in its entirety.

### TECHNICAL FIELD

The present disclosure is directed to automatic placement of virtual objects, in an artificial reality (XR) environment, to avoid occlusions in the real-world environment.

### BACKGROUND

Artificial reality (XR) devices are becoming more prevalent. As they become more popular, the applications implemented on such devices are becoming more sophisticated. Mixed reality (MR) and augmented reality (AR) applications can provide interactive three-dimensional (3D) experiences that combine images of the real-world with virtual objects, while virtual reality (VR) applications can provide an entirely self-contained 3D computer environment. For example, an MR or AR application can be used to superimpose virtual objects over a real scene that is observed by a camera. A real-world user in the scene can then make gestures captured by the camera that can provide interactivity between the real-world user and the virtual objects. AR, MR, and VR (together XR) experiences can be observed by a user through a head-mounted display (HMD), such as glasses or a headset. An HMD can have a pass-through display, which allows light from the real-world to pass through a lens to combine with light from a waveguide that simultaneously emits light from a projector in the HMD, allowing the HMD to present virtual objects intermixed with real objects the user can actually see.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5 is a flow diagram illustrating a process used in some implementations of the present technology for avoiding occlusion in rendering virtual objects in an artificial reality (XR) environment.

FIG. 6A is a conceptual diagram illustrating an example view, of an XR environment on an XR system, of a virtual object occluding a physical object in a real-world environment surrounding the XR system.

FIG. 6B is a conceptual diagram illustrating an example view, of an XR environment on an XR system, of a virtual object repositioned in the XR environment so as to avoid occlusion of a physical object in a real-world environment surrounding the XR system.

FIG. 7 is a flow diagram illustrating a process used in some implementations of the present technology for minimizing virtual objects in an XR environment based on identified motion of a user of an XR system.

FIG. 8A is a conceptual diagram illustrating an example view, of an XR environment on an XR system, of a virtual object in a maximized form while movement, of a user of the XR system, is below a threshold.

FIG. 8B is a conceptual diagram illustrating an example view, of an XR environment on an XR system, of a virtual object in a minimized form while movement, of a user of the XR system, is at or above a threshold.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure relate to automatic repositioning of virtual objects, in an augmented reality (AR) or mixed reality (MR) environment, to avoid occlusion of certain physical objects or views of the real-world environment. Conventionally, on a head-worn artificial reality (XR) device, head-leashed virtual objects simply follow where the head is pointed. In some implementations, an occlusion avoidance system can detect regions in the field-of-view of the user that should not be occluded, such as faces of other people, media content (e.g., on a laptop, television, or mobile phone), a particular activity being performed (e.g., taking notes, cooking, etc.), and/or where the user's gaze has lingered. The occlusion avoidance system can automatically reposition head-leashed virtual objects to avoid these areas (and, in some implementations, on all axes). In some implementations, the occlusion avoidance system can reposition the virtual objects based on plane detection (e.g., empty wall area), or based on a user's indicated preference.

Alternatively or additionally, the occlusion avoidance system can minimize head-leashed virtual objects when the user of the XR system is in motion. For example, the occlusion avoidance system can detect a threshold amount of movement (e.g., by inertial measurement units (IMUs) in the XR system and/or wearable devices, such as a smart watch), and trigger minimization (and possibly repositioning) of virtual objects while the user is moving. Thus, the occlusion avoidance system can conserve resources and minimize obstructions from the user's viewpoint of the real-world environment. After the user slows down or stops moving (with a small amount of delay to ensure that the virtual object does not come in or out too often), the virtual object can expand back into its full form.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

The implementations described herein provide specific technological improvements in the fields of augmented and mixed reality. Some implementations of the avoidance occlusion systems and methods described herein can automatically reposition virtual objects such that they do not occlude (e.g., overlap with) physical object(s) in the user's real-world environment that would affect (and, in some cases, degrade) the user experience, the XR experience, and/or collision of the user with physical objects when engaging with the XR experience. For example, by repositioning virtual objects away from certain identified physical objects in the real-world environment, the user can view and interact with such virtual objects and physical objects concurrently and/or simultaneously, thereby providing for improved multitasking by the user in the XR and real-world environments. Further, by avoiding occlusion of certain physical objects by virtual objects, the user can see and comprehend that such physical objects are present in the real-world environment, and avoid colliding with such physical objects when accessing the XR environment. In addition, processing resources can be conserved, and latency improved, on the XR system by automatically repositioning virtual objects when both they and particular physical objects (which may both be crucial to the XR experience) cannot be seen and interacted with by the user.

In some implementations, the occlusion avoidance systems and methods described herein can alternatively or additionally apply one or more degradations to the virtual object when it does or is predicted to occlude one or more identified physical objects in the real-world environment (such as, e.g., when the virtual object will be rendered at a particular specified position, based on a trajectory of movement of the user or user's head when the virtual object is leashed to the user or user's head, etc.), and/or when the user is in movement in the real-world environment. The degradations can include, for example, dimming the virtual object, pausing rendering updates to the virtual object, pausing movement of the virtual object, making the virtual object translucent, darkening the virtual object, minimizing the virtual object (e.g., resizing the virtual object to a smaller size or simplifying the virtual object such as to an icon), etc. By applying one or more degradations to the virtual object in such cases, power and processing resources can be conserved on the XR system. Further, the user's XR experience can be improved, as well as integration of the XR experience with the real world, allowing for multitasking in both the XR and real-world environments with minimal obstructions.

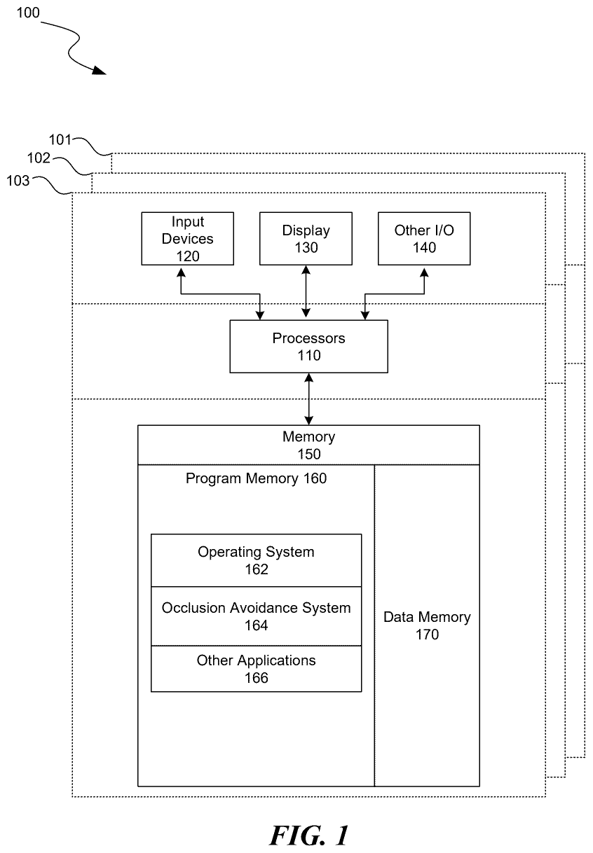

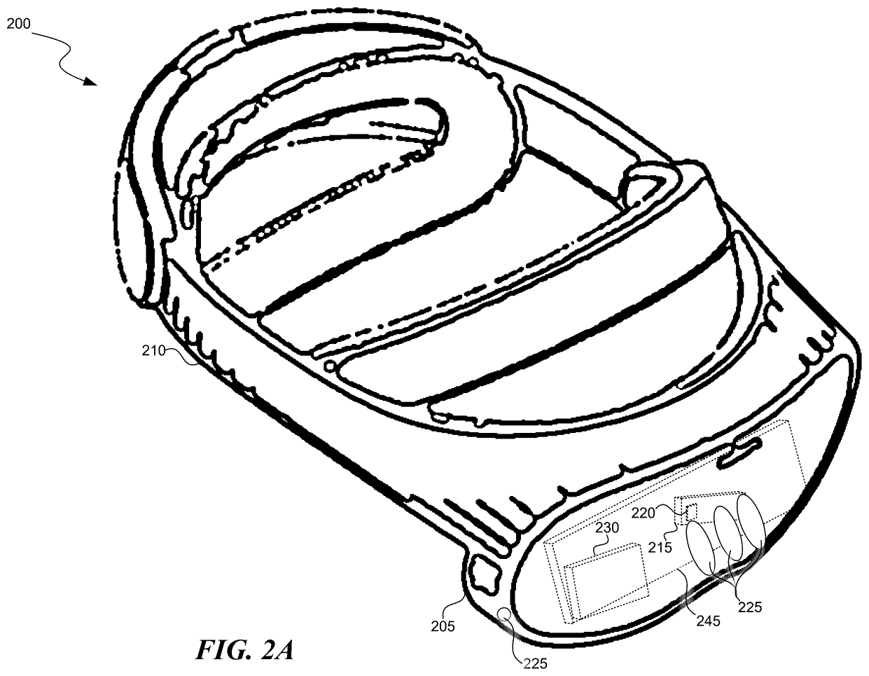

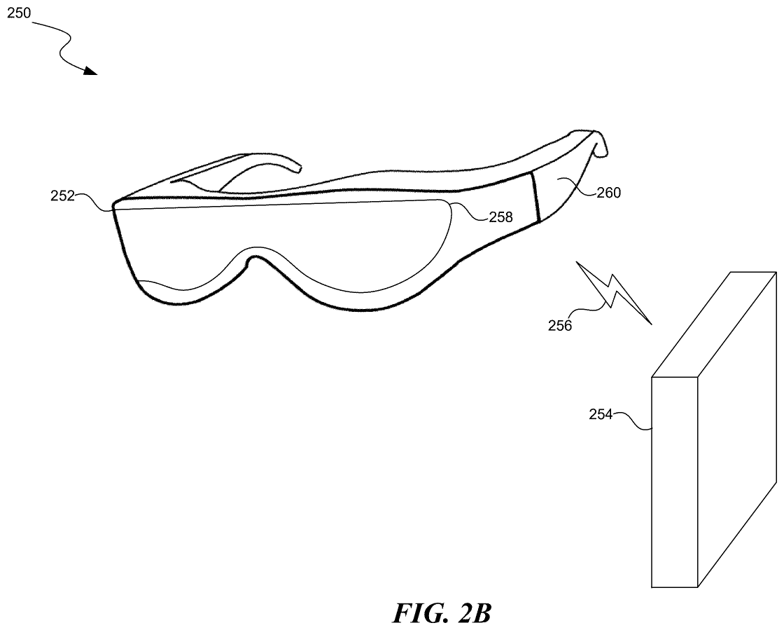

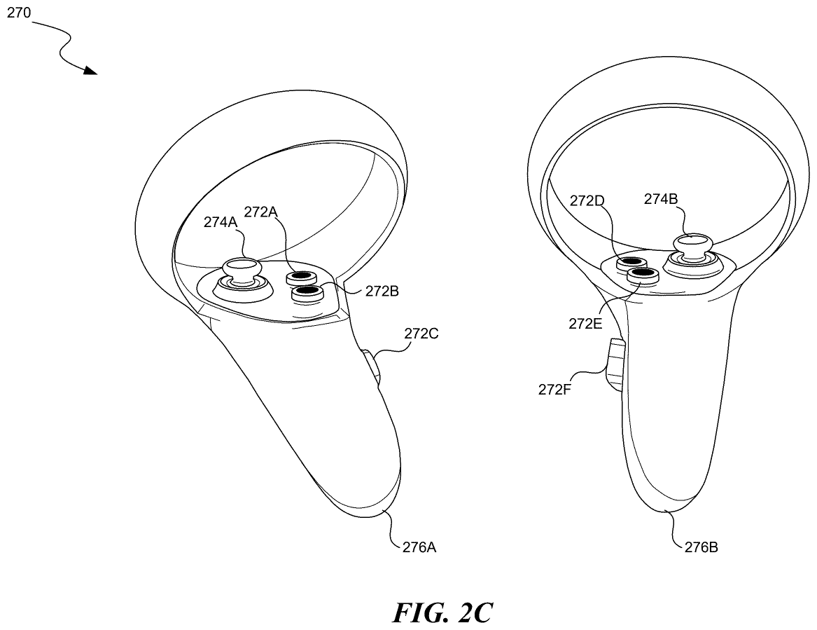

Several implementations are discussed below in more detail in reference to the figures. FIG. 1 is a block diagram illustrating an overview of devices on which some implementations of the disclosed technology can operate. The devices can comprise hardware components of a computing system 100 that can avoid occlusion in rendering virtual objects in an artificial reality environment. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, grids, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, occlusion avoidance system 164, and other application programs 166. Memory 150 can also include data memory 170 that can include, e.g., e.g., position data, rendering data, physical object data, object recognition data, model training data, gaze data, movement data, virtual object data, degradation data, configuration data, settings, user options or preferences, etc., which can be provided to the program memory 160 or any element of the computing system 100.

In various implementations, the technology described herein can include a non-transitory computer-readable storage medium storing instructions, the instructions, when executed by a computing system, cause the computing system to perform steps as shown and described herein. In various implementations, the technology described herein can include a computing system comprising one or more processors and one or more memories storing instructions that, when executed by the one or more processors, cause the computing system to steps as shown and described herein.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. In this example, HMD 200 also includes augmented reality features, using passthrough cameras 225 to render portions of the real world, which can have computer generated overlays. The HMD 200 includes a front rigid body 205 and a band 210. The front rigid body 205 includes one or more electronic display elements of one or more electronic displays 245, an inertial motion unit (IMU) 215, one or more position sensors 220, cameras and locators 225, and one or more compute units 230. The position sensors 220, the IMU 215, and compute units 230 may be internal to the HMD 200 and may not be visible to the user. In various implementations, the IMU 215, position sensors 220, and cameras and locators 225 can track movement and location of the HMD 200 in the real world and in an artificial reality environment in three degrees of freedom (3DoF) or six degrees of freedom (6DoF). For example, locators 225 can emit infrared light beams which create light points on real objects around the HMD 200 and/or cameras 225 capture images of the real world and localize the HMD 200 within that real world environment. As another example, the IMU 215 can include e.g., one or more accelerometers, gyroscopes, magnetometers, other non-camera-based position, force, or orientation sensors, or combinations thereof, which can be used in the localization process. One or more cameras 225 integrated with the HMD 200 can detect the light points. Compute units 230 in the HMD 200 can use the detected light points and/or location points to extrapolate position and movement of the HMD 200 as well as to identify the shape and position of the real objects surrounding the HMD 200.

The electronic display(s) 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

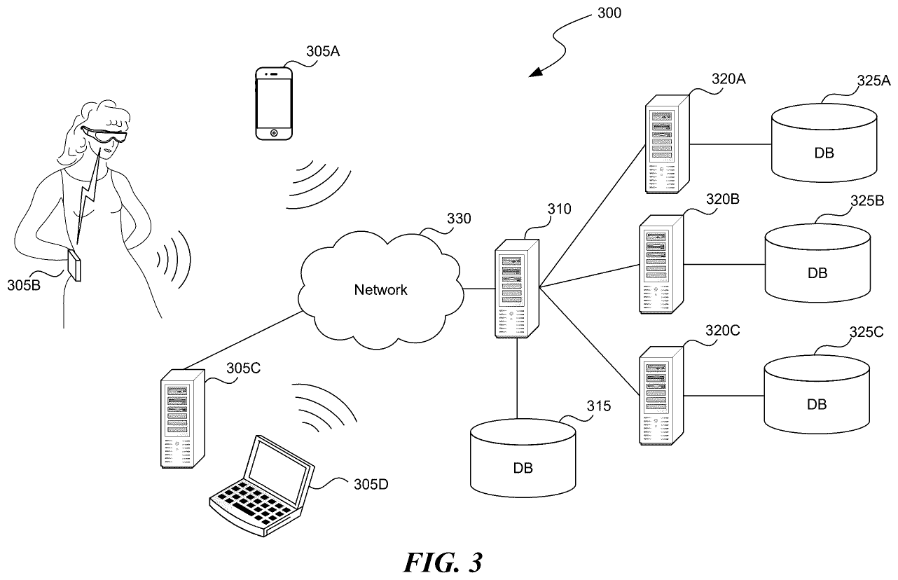

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

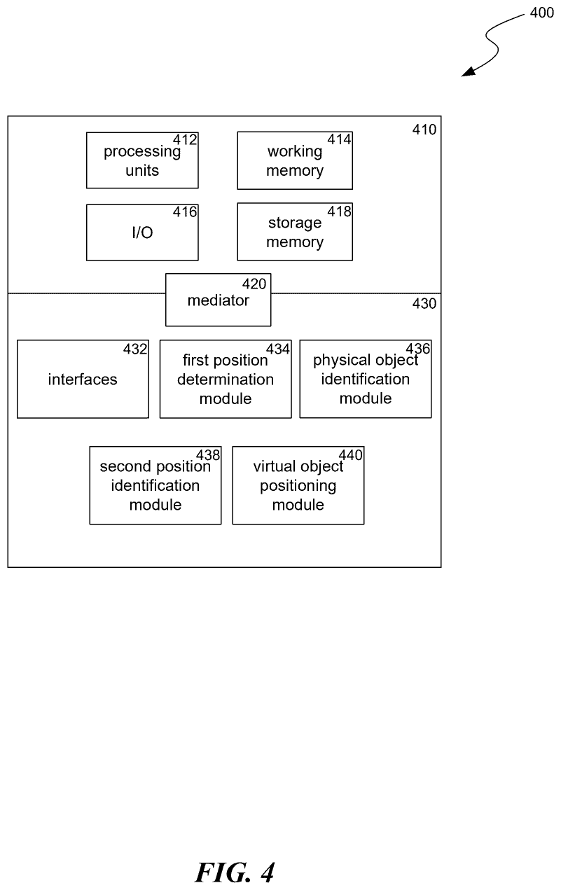

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for avoiding occlusion in rendering virtual objects in an artificial reality (XR) environment. Specialized components 430 can include first position determination module 434, physical object identification module 436, second position identification module 438, virtual object positioning module 440, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

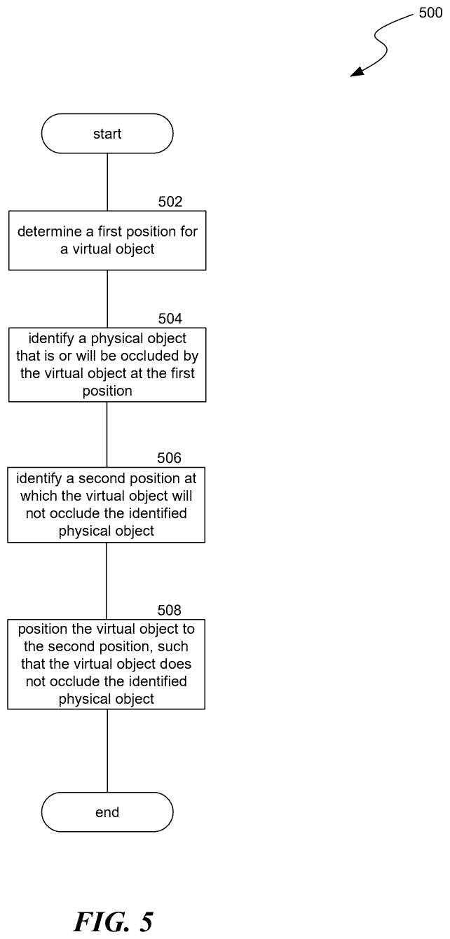

First position determination module 434 can determine a first position for a virtual object, in an XR environment, at which to overlay the virtual object on a view of a real-world environment surrounding an XR system. In some implementations, the first position can be a default position (e.g., at the center of the display of the XR system or other default position). In some implementations, the first position can be specified by the XR application managing the virtual object, the XR system, and/or the user of the XR system. In some implementations, the first position can be based on where the virtual object is or would be located relative to the head of the user of the XR system (e.g., when the virtual object is or would be “head-leashed,” or locked, to the position of the user's head, such that movement of the virtual object tracks or would track movement of the head of the user from an origin point, e.g., corresponding to the first position). Further details regarding determining a first position for a virtual object at which to overlay the virtual object on a view of a real-world environment surrounding an XR system are described herein with respect to block 502 of FIG. 5.

Physical object identification module 436 can identify, based on an avoidance trigger determined by the XR system, a physical object, in the real-world environment, that is or will be occluded by the virtual object at the first position in the XR environment (e.g., as rendered in an augmented or mixed reality mode). For example, if the virtual object is “head-leashed” as described above, physical object identification module 436 can identify a physical object that is or will be occluded by the user moving their head, and thereby moving the virtual object a corresponding amount, to overlap with an identified physical object. In another example, if the virtual object is or will be placed at a default, application-level, system-level, or user-level specified position in the real-world environment, physical object identification module 436 can identify a physical object that is or will be occluded at such a position.

In some implementations, the avoidance trigger can include identification of a physical object that is within one or more specified boundaries (collectively referred to interchangeably herein as a “guardian”) for the XR environment. As used herein, a “guardian” can be a defined XR usage space, for an XR experience or environment, in a real-world environment. If a user, wearing an XR system, crosses the boundary when accessing an XR experience, one or more system actions or restrictions can be triggered on the XR system. For example, the XR system can display a warning message on the XR system, can activate at least partial pass-through on the XR system, can display the boundary on the XR system, can pause rendering of or updates to the XR environment, etc.

In some cases, however, such a boundary may not include all or certain physical objects with which a user may collide in the real-world environment. For example, the boundary may correspond only to the walls of the real-world environment, while physical objects are positioned within the walls, and therefore, within the boundary. In another example, the boundary may omit moveable physical objects, which may not have been present when the XR system generated the boundary, but which may enter the boundary when the user accesses the XR environment (e.g., pets, children, movable electronics such as automatic vacuums, etc.). In some implementations, physical object identification module 436 can identify such physical objects that are within the boundary (e.g., by comparing a scan of the real-world environment to the guardian or mesh previously established for the real-world environment, as described further herein) as an avoidance trigger if the first position of the virtual object would occlude such physical object(s). Thus, when the virtual object is later rendered at a second position away from such physical object(s), the XR system can avoid collision of the user with the physical object(s), which the user may not otherwise see or understand would impeding their movement in the real-world environment while accessing the XR environment.

In some implementations, if an identified physical object is in active movement when physical object identification module 436 determines that the first position of the virtual object would occlude the physical object, physical object identification module 436 can decline to identify the physical object as an avoidance trigger, as the physical object is unlikely to remain at the position that is or would be occluded by the virtual object. In some implementations, physical object identification module 436 can identify a physical object in movement as an avoidance trigger if it remains at the position that is or would be occluded by the virtual object for greater than a threshold amount of time (e.g., 3 seconds). Further details regarding determining boundaries for a real-world environment are described in U.S. patent Ser. No. 18/771,009, filed Jul. 12, 2024, entitled “Automatic Boundary for an Artificial Reality Environment,” which is herein incorporated by reference in its entirety.

In some implementations, the avoidance trigger can include an activity related to the physical object being performed by a user of the XR system. For example, physical object identification module 436 can determine that the user is interacting with a physical object (e.g., petting a dog in the real-world environment), and thereby determine that the physical object should not be occluded by the virtual object when the virtual object does or will occlude the physical object. In some implementations, the avoidance trigger can include the physical object being a face of another user in the view of the real-world environment on the XR system, as identified by physical object identification module 436. In some implementations, the avoidance trigger can include identification that the physical object is a display showing media content in the view of the real-world environment on the XR system (e.g., a television, a tablet, a laptop or other computing device, a mobile phone or other mobile device, etc.), which physical object identification module 436 can determine to be illuminated using one or more cameras and/or other light detection sensor(s). In some implementations, physical object identification module 436 can identify such physical object(s) as avoidance triggers by performing object detection and/or recognition techniques on one or more images captured by the XR system (or one or more other image capture devices, such as external camera(s)) showing the real-world environment surrounding the XR system.

In some implementations, the avoidance trigger can include identification that a gaze, of the user of the XR system, has dwelled on the identified physical object for at least a threshold period of time. For example, the XR system can include one or more image capture devices (e.g., cameras) facing inward toward the eye(s) of the user of the XR system and capturing image(s) of the eyes of the user. Physical object identification module 436 can analyze such images to determine a position and/or gaze direction of the eye(s), measure the time that the eye(s) are at such a position and gaze direction, and, if such a time is greater than a threshold (e.g., 5 seconds), can identify a physical object in the real-world environment to which the position and/or gaze direction of the eyes correspond. Further details regarding identifying a physical object in a real-world environment that is or will be occluded by a virtual object at a first position in an XR environment are described herein with respect to block 504 of FIG. 5.

Second position identification module 438 can identify a second position at which the virtual object will not occlude the identified physical object. For example, by performing object recognition and/or detection (or any other suitable techniques), second position identification module 438 can identify the x-, y-, and/or z-axis boundaries of the physical object in the real-world environment, then identify the second position at which the virtual object will not occlude the physical object on one or more (or all) of these axes. In some implementations, when the virtual object is “head-leashed” to the user at the first position, as described further herein, the second position need not correspond to or track the position, movement, and/or orientation of the head of the user, when the physical object would be occluded by the virtual object at the otherwise head-leashed position.

In some implementations, second position identification module 438 can identify the second position by identifying a plane in the real-world environment, such as a wall, a floor, a ceiling, and/or any other flat surface in the real-world environment (e.g., the front of a cabinet, a door, etc.). In some implementations, second position identification module 438 can determine such plane(s) in the real-world environment by analyzing captured images of the real-world environment, such as by performing object recognition and/or detection techniques. In some implementations, second position identification module 438 can determine such plane(s) in the real-world environment, either separately with or in conjunction with one or more images, using measurements made by one or more depth sensors, such as by identifying areas having surfaces of continuously and constantly changing depths relative to the XR system. In some implementations, second position identification module 438 can determine such plane(s) based on an XR space model of the real-world environment and/or a mesh of the real-world environment generated by the XR system (or generated by another XR system and obtained by the XR system), as described further herein. In some implementations, second position identification module 438 can determine the second position based on an application-, system-, or user-specified position that does not occlude the physical object, and/or at a second default position that does not occlude the physical object. Further details regarding identifying a second position at which a virtual object will not occlude an identified physical object are described herein with respect to block 506 of FIG. 5.

Virtual object positioning module 440 can position the virtual object at the second position, in the XR environment, overlaid onto the view of the real-world environment, such that the virtual object does not occlude the identified physical object. For example, virtual object positioning module 440 can render the virtual object at the second position on a display of the XR system in an augmented or mixed reality mode. In some implementations, when the virtual object was head-leashed to the object at the first position, virtual object positioning module 440 can “unleash” the virtual object from the head of the user to reposition the virtual object at the second position (which may not otherwise correspond to movement of the user's head), then “releash” the virtual object to the user's head at the second position. In other words, virtual object positioning module 440 can specify the second position as a new origination point for the virtual object from which movement of the head causes corresponding movement of the virtual object in the XR environment. In some implementations, however, virtual object positioning module 440 need not leash or releash the virtual object to the second position, and movement of the virtual object can be independent from, and/or not track movement of, the head of the user of the XR system. In some implementations, virtual object positioning module 440 can “world lock” the virtual object at the second position, i.e., have the virtual object maintain a constant position within and relative to the real-world environment, regardless of movement of the user and/or the user's head within the real-world environment. Further details regarding positioning a virtual object to a second position, rendered as overlaid onto a view of a real-world environment, such that the virtual object does not occlude an identified virtual object, are described herein with respect to block 508 of FIG. 5.

Those skilled in the art will appreciate that the components illustrated in FIGS. 1-4 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 5 is a flow diagram illustrating a process 500 used in some implementations for avoiding occlusion in rendering virtual objects in an artificial reality (XR) environment. In some implementations, the XR environment can be a mixed reality (MR) or augmented reality (AR) environment. In some implementations, process 500 can be performed as a response to a system-level, application-level, and/or user-initiated request to render a virtual object. In some implementations, process 500 can be fully or partially performed by an XR system, which can include one or more XR devices. For example, in some implementations, process 500 can be fully or partially performed by an XR HMD, e.g., XR HMD 200 of FIG. 2A and/or XR HMD 252 of FIG. 2B. In some implementations, process 500 can be fully or partially performed by one or more other XR devices in an XR system, either in conjunction with or separate from an XR HMD, such as one or more external processing components. In some implementations, process 500 can be performed by occlusion avoidance system 164 of FIG. 1. In some implementations, process 500 can be performed by specialized components 430 of FIG. 4.

At block 502, process 500 can determine a first position for a virtual object, in an XR environment on an XR system, at which to overlay the virtual object on a view of a real-world environment surrounding the XR system. Process 500 can determine the first position for the virtual object based on, for example, an application-level, system-level, or user request to place the virtual object at a particular position. In some implementations, process 500 can determine the first position for the virtual object based on a default position assigned to the virtual object. In some implementations, process 500 can determine the first position for the virtual object based on one or more application- or system-defined placement and/or rendering rules for the virtual object based on any of a number of factors, such as type, size, dimensions, characteristics (e.g., static, dynamic, animated, interactive, etc.), layout, placement of other virtual objects in the XR environment, etc. In some implementations, process 500 can render the virtual object at the first position in the XR environment, while in other implementations, process 500 can merely determine the first position for the virtual object without rendering the virtual object at the first position.

In some implementations, the virtual object can be “head-leashed,” i.e., rendered or to be rendered at a particular position based upon the position and/or orientation of the head of the user of the XR system, such that movement of the virtual object tracks movement of the head of the user. In some implementations, the position, orientation, and/or movement of the head of the user can be tracked by one or more sensors of an inertial measurement unit (IMU) integral with the XR system worn on the user's head. In some implementations, the position, orientation, and/or movement of the head of the user can be tracked via one or more images, of the real-world environment surrounding the XR system, captured by the XR system. Although described primarily herein as the virtual object being head-leashed, it is contemplated that, in some implementations, the virtual object can be “world-locked,” i.e., have a constant position in the XR environment, relative to the real-world environment surrounding the XR system, regardless of movement of the head of the user of the XR system. Further, it is contemplated that, in some implementations, regardless of whether the virtual object is head-leashed or world-locked, the virtual object can be dynamic and can, for example, move within the XR environment relative to the user's head movement and/or the world-locked position.

At block 504, process 500 can identify, based on an avoidance trigger captured by the XR system, a physical object, in the real-world environment, that is or will be occluded by the virtual object at the first position in the XR environment. In some implementations, the avoidance trigger can include a face of a person in the real-world environment within the field-of-view of the user of the XR system, and the identified physical object can be the face. In some implementations, the avoidance trigger can include media content in the real-world environment, such as a television show, movie, application, website, and/or any other visual content rendered on an electronic device, such as a television, a computer, a tablet, a mobile phone, etc., and the identified physical object can be the electronic device showing the media content. In some implementations, process 500 can detect media content on the electronic device by detecting an area of brightness above a threshold (e.g., corresponding to a display screen) in the real-world environment. In some implementations, the avoidance trigger can include an activity being performed by the user of the XR system, such as cooking, reading, taking notes, etc., and the identified physical object can be associated with the activity being performed (e.g., a pot, a recipe, a book, a notepad, etc.). In some implementations, the avoidance trigger can be a window through which the user can look or is looking (e.g., based on the user's gaze). In some implementations, the avoidance trigger can include any other physical object manually identified by the user of the XR system. Process 500 can identify such physical object(s) as being or would be occluded when it would be overlapped by the virtual object if rendered at the first position.

In some implementations, process 500 can identify the physical object (e.g., a face, an electronic device, a physical object associated with an activity being performed, a window, etc.) via computer vision techniques. For example, process 500 can capture one or more images of the real-world environment surrounding the XR system, and can identify the physical object by applying object detection and/or object recognition techniques. Process 500 can perform object recognition using any suitable technique, such as template matching, color-based matching, active or passive recognition, shape-based recognition, image segmentation and blob analysis, etc., using artificial intelligence techniques. In some implementations, process 500 can apply machine learning algorithms and/or deep learning models in order to learn the features of many different types of physical objects in order to predict and identify physical object(s) within a particular image captured by the XR system. Such features can include, for example, color, texture, edges, corners, shapes, sizes, curves, dimensions, etc.

In some implementations, the avoidance trigger can include a gaze, of the user of the XR system, dwelling on the physical object for at least a threshold period of time (e.g., 10 seconds). In one example, process 500 can determine that the user's gaze is beyond the focal plane of the virtual object when rendered at the first position, and/or is focused on a particular physical object beyond the first position when the virtual object has not been rendered at the first position. Process 500 can capture the gaze of the user via, for example, one or more face-pointed cameras integral with the XR system. Process 500 can then extrapolate the gaze direction of the user's eyes into the real-world environment to determine a physical object on which the gaze is directed. Process 500 can identify that physical object as being or would be occluded if would be overlapped by the virtual object if rendered at the first position. In some implementations, process 500 can identify multiple physical objects that is or will be occluded by the virtual object at the first position. In some implementations, process 500 can identify that the physical object should not be occluded based on a combination of two or more avoidance triggers.

At block 506, process 500 can identify a second position at which the virtual object will not occlude the identified physical object. The second position can be a position at which the virtual object will not occlude the identified physical object in at least one of the x-, y-, and/or z-axes. In some implementations, the second position can be a position at which the virtual object will not occlude the identified physical object in all of the x-, y-, and z-axes. In some implementations, process 500 can identify the second position by determining the boundaries of the identified physical object (e.g., through object recognition techniques as described above), as well as the boundaries of the virtual object (e.g., as identified through metadata and/or rendering rules associated with the virtual object), and determine a location in the real-world environment in which the physical object (as delineated by its boundaries) is not overlapped by the virtual object. In some implementations, process 500 can further identify the second position based on the second position having sufficient space to render the virtual object.

In some implementations, process 500 can identify the second position based on one or more factors additional to the virtual object not occluding the identified physical object. For example, in some implementations, process 500 can identify the second position based on a user-defined parameter for selecting the second position, such as a predefined user preference indicated in XR environment, XR application, and/or virtual object settings. In some implementations, process 500 can prompt the user, upon a determination that the physical object is or will be occluded by the virtual object at the first position at block 504, to enter a preference for the second position and/or manually select the second position in the XR environment in real-time or near real-time. In some implementations, however, process 500 can automatically select the second position.

In some implementations, process 500 can identify the second position based on an identified physical object and/or area in the real-world environment. For example, process 500 can identify one or more planes in the real-world environment, e.g., corresponding to the floor, the walls, the ceiling, etc., and select a position on an identified plane as the second position. In some implementations, process 500 can identify planes in the real-world environment by applying computer vision techniques to identify the walls, ceiling, floor, etc. in image(s) captured by the XR system. In some implementations, process 500 can obtain data identifying planes in the real-world environment that were previously captured, such as “guardian data” indicating boundaries within the real-world environment. Further details regarding capturing a real-world environment, from which planes and/or guardians can be identified, are described in U.S. patent application Ser. No. 18/346,379, filed Jul. 3, 2023, entitled “Artificial Reality Room Capture Realignment,” which is herein incorporated by reference in its entirety.

In some implementations, process 500 can identify planes in the real-world environment automatically by using depth sensors and/or imaging devices to identify the maximum boundaries of the real-world environment surrounding the XR system. Further details regarding determining planes based on the maximum boundaries of the real-world environment are described in U.S. patent application Ser. No. 18/771,009, filed Jul. 12, 2024, entitled “Automatic Boundary for an Artificial Reality Environment,” which is herein incorporated by reference in its entirety. In some implementations, process 500 can identify planes in the real-world environment based on a three-dimensional (3D) mesh generated by scanning the real-world environment with the XR system, such as is further described in U.S. patent application Ser. No. 18/454,349, filed Aug. 23, 2023, entitled “Assisted Scene Capture for an Artificial Reality Environment,” which is herein incorporated by reference in its entirety.

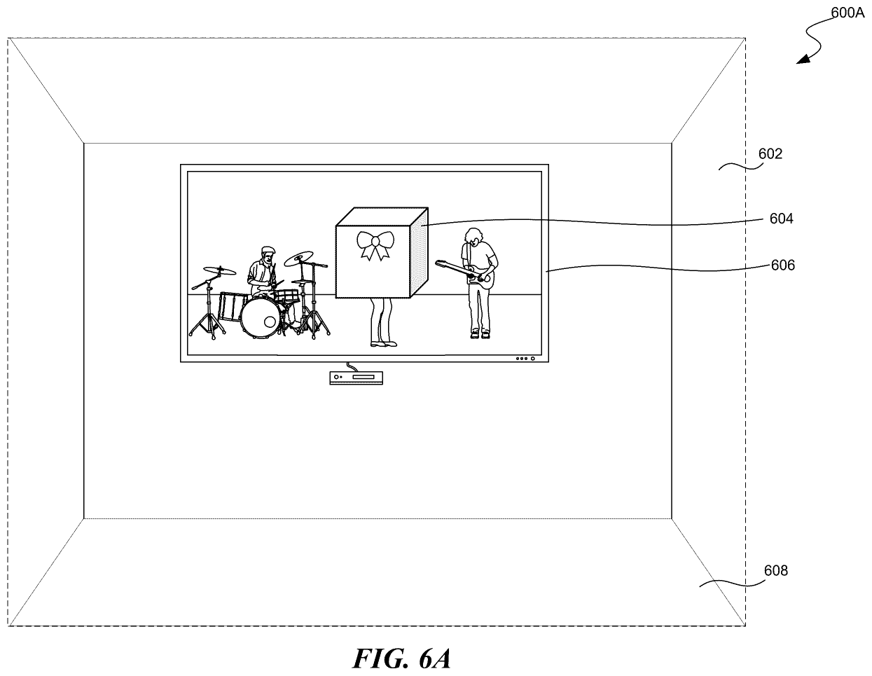

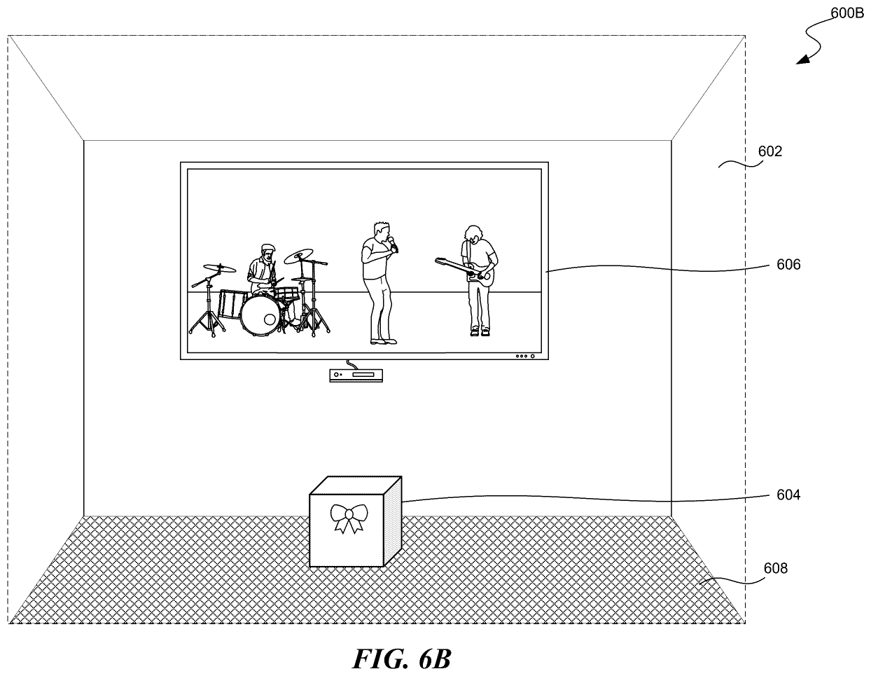

In some implementations, process 500 can identify planes in the real-world environment based on manual input from the user of the XR system, such as by the user pointing with a hand and/or placing a controller (e.g., controller 276A and/or 276B of FIG. 2C) on the floor, the walls, the ceiling, etc. In some implementations, the user can manually adjust the location of identified planes for the real-world environment. For example, the user can click and drag a controller relative to the planes and/or pinch and grab the planes with a hand, as detected via hand tracking techniques on the XR system. Example views of an occluding virtual object being relocated to an identified plane are shown and described herein with respect to FIGS. 6A and 6B. In some implementations, process 500 can identify other suitable physical objects on which to render the virtual object (e.g., a table, a chair, a counter, etc.), e.g., by applying computer vision techniques, by applying object recognition techniques, by applying a machine learning model, by accessing scene data identifying previously labeled physical objects in the real-world environment, etc.

At block 508, process 500 can reposition the virtual object to the second position, in the XR environment, rendered as overlaid onto the view of the real-world environment, such that the virtual object does not occlude the identified physical object. For example, if the virtual object was previously rendered at the first position, process 500 can relocate the virtual object at the second position. In some implementations, process 500 can transition the virtual object from the first position to the second position, e.g., by gradually moving the virtual object from the first position to the second position. In some implementations, however, process 500 can cause the virtual object to disappear from the first position, then appear at the second location. In another example, if the virtual object was not previously rendered at the first position, process 500 can cause the virtual object to be displayed on the XR system at the second position. In some implementations, process 500 can reposition the virtual content on the x-, y-, and/or z-axes.

In some implementations, when the virtual object is head-leashed at the first position as described above, process 500 can unleash the virtual object from the head of the user when the virtual object is repositioned to the second position, such that movement of the virtual object no longer tracks movement of the head at least when the virtual object is being repositioned. In some implementations, the virtual object can remain unleashed at the second position, e.g., become world-locked as described above. In some implementations, however, process 500 can releash the virtual object to the head of the user at the second position when the virtual object is repositioned. In other words, in some implementations, process 500 can head-leash the virtual object with the second position as a point of origin from which movement of the virtual object tracks movement of the head.

Although described primarily herein as repositioning the virtual object based on its current or predicted occlusion of an identified physical object, it is contemplated that process 500 can apply alternative or additional degradations to the virtual object based on its occlusion. For example, process 500 can alternatively or additionally cause the virtual object to fade, to darken, to become partially transparent, to have a lower refresh rate or stop updating, to become static, to be minimized to an icon, etc., or any combination thereof. By applying one or more degradations to the virtual object when it is occluding an identified physical object, power and processing resources can be conserved on the XR system. Further, it is contemplated that process 500 can, in some implementations, revert the virtual object to its nondegraded state and/or original position when the avoidance trigger is no longer detected, e.g., the user's gaze no longer dwells on the physical object, another user's face is no longer detected, the television is turned off, etc. Thus, the user's XR experience can be improved, as well as integration of the XR experience with the real world, allowing for multitasking in both the XR and real-world environments. Although illustrated as performed as one iteration, it is contemplated that process 700 can be performed repeatedly (e.g., simultaneously, concurrently, and/or consecutively) as further virtual objects are requested to be rendered on the XR system.

FIG. 6A is a conceptual diagram illustrating an example view 600A, of an artificial reality (XR) environment 602 on an XR system, of a virtual object 604 occluding a physical object 606 in a real-world environment surrounding the XR system (shown through the XR system or in pass-through in XR environment 602). Virtual object 604 (e.g., a virtual gift) can initially be rendered at a first position, as shown in view 600A, occluding physical object 606 (e.g., a television). In some implementations, virtual object 604 can be head-leashed (as described further herein), and thereby rendered at the first position based on movement of the user's head while wearing the XR system. An occlusion avoidance system (e.g., occlusion avoidance system 164 of FIG. 1) can identify physical object 606 as a television displaying media content (e.g., a concert), such as by applying object recognition techniques, by identifying a brightness level above a threshold on the display of physical object 606, etc. In some implementations, physical object 606 (and, in some examples, display of media content on physical object 606) can be an avoidance trigger that can cause the occlusion avoidance system to relocate virtual object 604. Although illustrated as being rendered on the XR system in view 600A, it is contemplated that, in some implementations, the occlusion avoidance system can determine the first position for virtual object 604, as well as its predicted occlusion of physical object 606, without rendering virtual object 604 at the first position.

FIG. 6B is a conceptual diagram illustrating an example view 600B, of an artificial reality (XR) environment 602 on an XR system, of a virtual object 604 repositioned in the XR environment 602 so as to avoid occlusion of a physical object 606 in a real-world environment surrounding the XR system. Based on identification of physical object 606 as an avoidance trigger, and based on occlusion of physical object 606 by virtual object 604 at the first position shown in view 600A of FIG. 6A, the occlusion avoidance system can determine a second position for virtual object 604 that does not occlude physical object 606. For example, the occlusion avoidance system can identify plane 608 (indicated by cross-hatching for purposes of illustration) corresponding to the floor in the real-world environment, using any of the one or more techniques described herein with respect to FIG. 5. The occlusion avoidance system can then relocate virtual object 604 to plane 608 such that it does not occlude physical object 606, as shown in view 600B.

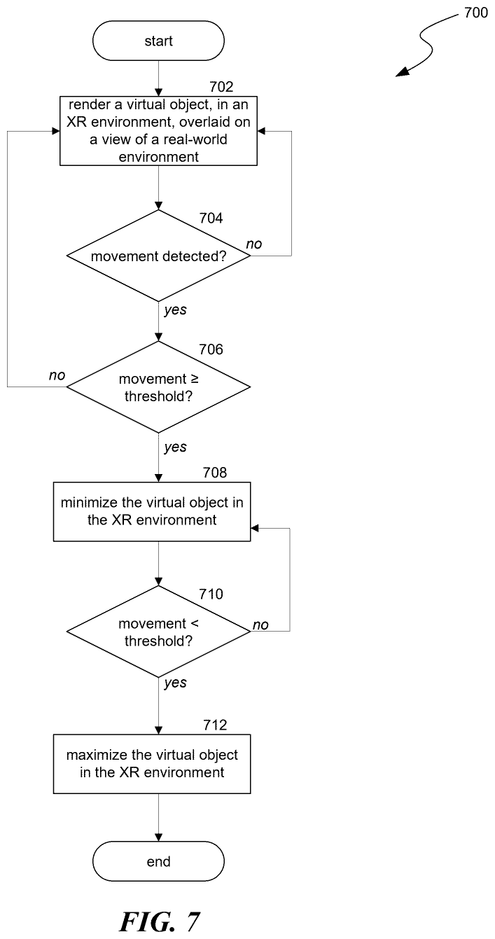

FIG. 7 is a flow diagram illustrating a process 700 used in some implementations of the present technology for minimizing virtual objects in an artificial reality (XR) environment based on identified motion of a user of an XR system. In some implementations, the XR environment can be a mixed reality (MR) or augmented reality (AR) environment. In some implementations, process 700 can be performed as a response to a system-level, application-level, and/or user request to render a virtual object. In some implementations, process 700 can be performed by an XR system, which can include one or more XR devices. For example, in some implementations, process 700 can be fully or partially performed by an XR HMD, e.g., XR HMD 200 of FIG. 2A and/or XR HMD 252 of FIG. 2B. In some implementations, process 700 can be fully or partially performed by one or more other XR devices in an XR system, either separate from or in conjunction with an XR HMD, such as one or more external processing components. In some implementations, process 700 can be performed by occlusion avoidance system 164 of FIG. 1.

At block 702, process 700 can render a virtual object, in an XR environment on an XR system, overlaid on a view of a real-world environment surrounding the XR system. Process 700 can initially render the virtual object in a “full” or “maximized” form, e.g., in the size indicated by the XR application and/or XR system requesting rendering of and/or providing rendering rules for the virtual object in the XR environment. Process 700 can further initially render the virtual object at a location in the XR environment indicated by the XR application and/or XR system requesting rendering of and/or providing rendering rules for the virtual object, e.g., at a certain part of the display, relative to a particular physical object, based on a layout of the virtual object relative to other virtual objects in the XR environment, etc. In some implementations, process 500 can render the virtual object as “head-leashed,” as defined further herein. In some implementations, however, it is contemplated that process 700 can render the virtual object as “world-locked,” as defined further herein.

At block 704, process 700 can determine whether movement, of a user of the XR system, is detected. In some implementations, process 700 can determine whether movement, of the user of the XR system, is detected based upon data captured by one or more sensors of an inertial measurement unit (IMU), one or more global positioning system (GPS) sensors, and/or one or more electromyography (EMG) sensors. In some implementations, the one or more sensors can be included in the XR system (e.g., XR HMD 200 of FIG. 2A and/or XR HMD 252 of FIG. 2B). In some implementations, the one or more sensors can be included in a smart device external to the XR system, such as a wearable device (e.g., a smart watch, a health or fitness tracker, etc.), a mobile device (e.g., a mobile phone), and/or the like, worn or carried by the user of the XR system, and in operable communication with the XR system. In some implementations, process 700 can determine whether movement, of the user of the XR system, is detected based upon images captured by the XR system indicative of motion, e.g., by comparing positions of objects in successive views from a camera. In some implementations, process 700 can obtain movement measurements from one or more same or different types of sensors on one or more different devices (e.g., an XR HMD and a smart watch).

If movement, of the user of the XR system, is not detected at block 704, process 700 can return to block 702, and continue to render the virtual object in the XR environment. If movement, of the user of the XR system, is detected at block 704, process 700 can proceed to block 706. At block 706, process 700 can determine whether the detected movement, of the user of the XR system, is at or above a threshold. For example, process 700 can determine whether measurements collected by an accelerometer exceed a certain value. Process 700 can determine whether the detected movement is at or above the threshold on any one or any combination of the x-, y-, or z-axes. In some implementations, process 700 can combine measurements of the detected movement on any combination of the x-, y-, or z-axes, and compare the combined measurement to the threshold.

If movement, of the user of the XR system, is determined to be below the threshold at block 706, process 700 can return to block 702, and continue to render the virtual object in the XR environment. If movement, of the user of the XR system, is determined to be above the threshold at block 706, process 700 can proceed to block 708. At block 708, process 700 can minimize the virtual object in the XR environment, while movement, of the user of the XR system, is detected and determined to be above the threshold. In some implementations, process 700 can minimize the virtual object by resizing and/or rescaling the virtual object to be a fraction or percentage of its original size. In some implementations, process 700 can minimize the virtual object by replacing the virtual object with a smaller icon, e.g., a simplified version of the virtual object having less detail, a symbol representing the virtual object, etc.

In some implementations, process 700 can further relocate the minimized virtual object in the XR environment. In some implementations, process 700 can relocate the minimized virtual object to a predefined default area, e.g., to the periphery of the user's field-of-view (e.g., upper or lower corners of the user's field-of view). In some implementations, process 700 can relocate the minimized virtual object to an area preselected or selected “on-the-fly” by the user of the XR system. In some implementations, process 700 can determine the gaze direction of the user (e.g., by tracking the eyes of the user via one or more cameras pointed toward the face of the user), and relocate the minimized virtual object to an area outside of the gaze direction of the user.

At block 710, process 700 can determine whether the detected movement, of the user of the XR system, has dropped below the threshold. For example, process 500 can continuously or periodically measure (or obtain measurements of) movement of the user, e.g., from an IMU, from a GPS, from an EMG sensor, from one or more images, etc. Process 700 can then continuously or periodically compare such measurements to the threshold to determine if they have fallen below the threshold. In some implementations, process 700 can further determine whether the detected movement has remained below the threshold for a predefined period of time (e.g., 5 seconds, 10 seconds, etc.).

If the detected movement, of the user of the XR system, has not dropped below the threshold as determined at block 710, process 700 can return to block 708, and continue to minimize the virtual object in the XR environment. If the detected movement, of the user of the XR system, has dropped below the threshold as determined at block 710, process 700 can proceed to block 712. At block 712, based on the determination that the detected movement has dropped below the threshold at block 710 (and, in some implementations, for a predefined period of time), process 700 can maximize the virtual object in the XR environment, i.e., revert the virtual object to its full form, as rendered at block 702. In some implementations, process 700 can further revert the virtual object to its original location in the XR environment.

In some implementations, process 700 can maximize the virtual object in the XR environment after a predefined delay (e.g., 5 seconds) after determining that the detected movement has fallen below the threshold. Although illustrated as performed as one iteration, it is contemplated that process 700 can be performed repeatedly (e.g., simultaneously, concurrently, and/or consecutively) as further virtual objects are rendered on the XR system. Thus, by implementing a brief delay in maximizing the virtual object after movement slows or stops and/or by ensuring that movement has slowed or stopped for a predefined period of time, process 700 can prevent the virtual object from switching from a maximized to minimized form too quickly and/or too often when process 700 is performed repeatedly.

Although described primarily herein as minimizing the virtual object based on movement of the user, it is contemplated that process 700 can apply alternative or additional degradations to the virtual object based on the user's movement. For example, process 700 can alternatively or additionally cause the virtual object to fade, to darken, to become partially transparent, to become two-dimensional, to have a lower refresh rate or stop updating, to become static, etc., or any combination thereof. By applying one or more degradations to the virtual object when the user is moving, power and processing resources can be conserved on the XR system. Further, the user's XR experience can be improved, as well as integration of the XR experience with the real world, allowing for multitasking in both the XR and real-world environments with minimal obstructions.

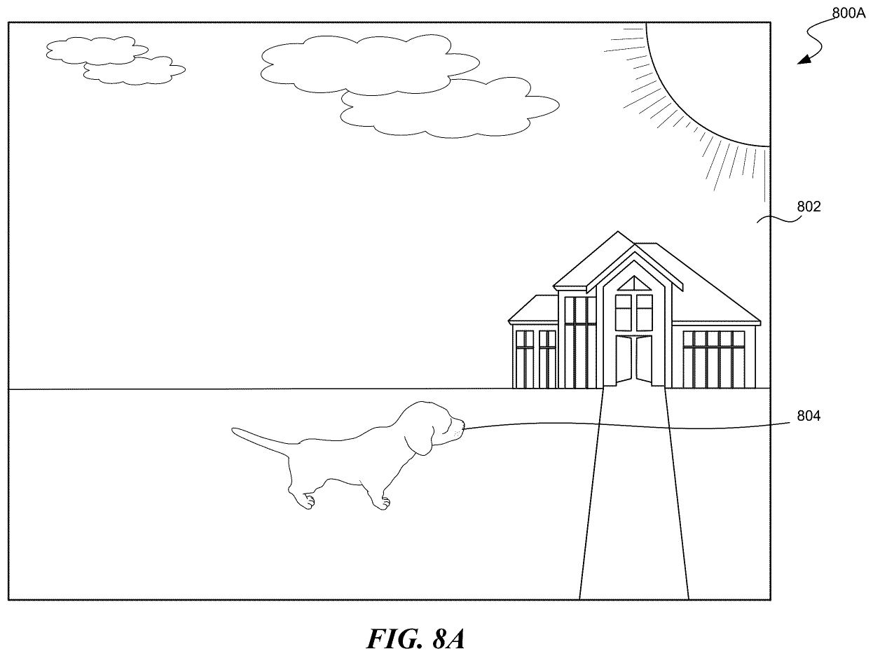

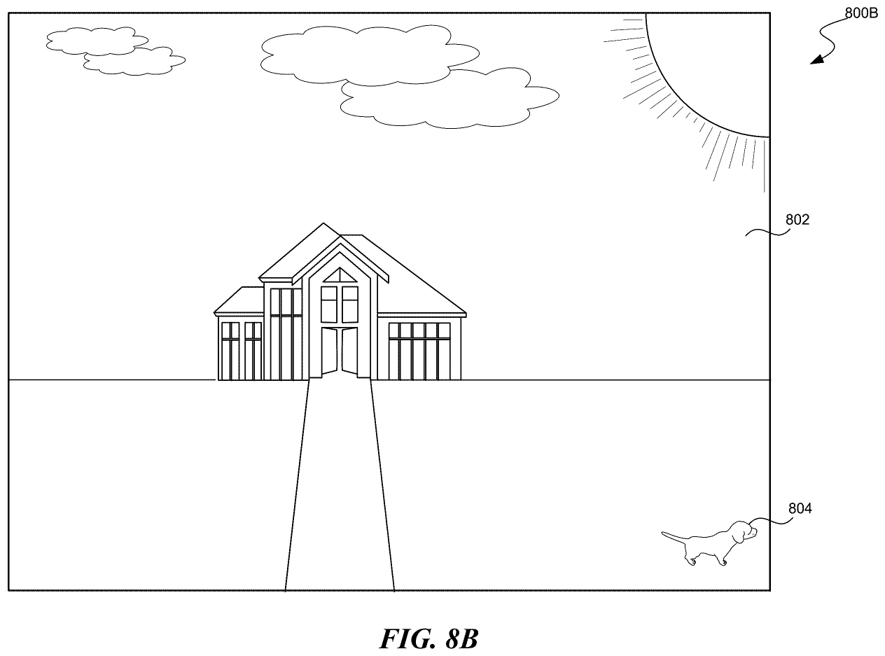

FIG. 8A is a conceptual diagram illustrating an example view 800A, of an artificial reality (XR) environment 802 on an XR system, of a virtual object 804 in a maximized form while movement, of a user of the XR system in a real-world environment (shown through the XR system or in pass-through in XR environment 802), is below a threshold. In some implementations, the XR system and/or one or more wearable devices having one or more motion sensors (e.g., an accelerometer, a gyroscope, etc.) can measure movement of the user of the XR system in the real-world environment. While the user is static (or the movement measurements are below a threshold), the XR system can render virtual object 804 (e.g., a virtual dog) in its full-size form as shown in view 800A, and as intended by the XR application requesting rendering of virtual object 804. In some implementations, virtual object 804 can be head-leashed to the user of the XR system, as described further herein.

FIG. 8B is a conceptual diagram illustrating an example view 800B, of an artificial reality (XR) environment 802 on an XR system, of a virtual object 804 in a minimized form while movement, of a user of the XR system in a real-world environment, is at or above a threshold. In some implementations, the XR system and/or one or more wearable devices having one or more motion sensors (e.g., an accelerometer, a gyroscope, etc.) can measure movement of the user of the XR system in the real-world environment. When the movement measurements are at or above a threshold (indicating movement of the user, e.g., taking a run), the XR system can render virtual object 804 in a minimized form in view 800B, e.g., a scaled down version of virtual object 804 relative to view 800A of FIG. 8A. As shown in view 800B, the XR system can further, in some implementations, move virtual object 804 outside of the line-of-sight of the user (e.g., based on gaze detection) and/or move virtual object 804 to the periphery of view 800B (e.g., the lower right corner). Thus, the user of the XR system can have view 800B, with minimized obstruction by virtual object 804, while in movement. In some implementations, when the user slows and/or stops movement below the threshold (as detected by one or more motion sensors), virtual object 804 can revert to its full-sized form, such as that shown in view 800A of FIG. 8A.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for avoiding occlusion in rendering virtual objects in an artificial reality environment, the method comprising:
determining a first position for a virtual object, in the artificial reality environment on an artificial reality system, at which to overlay the virtual object on a view of a real-world environment surrounding the artificial reality system;
identifying, based on an avoidance trigger determined by the artificial reality system, a physical object in the real-world environment that is or will be occluded by the virtual object at the first position in the artificial reality environment,
wherein the determined avoidance trigger includes one or more of A) an activity related to the physical object being performed by a user of the artificial reality system, B) the physical object being a face of an other user in the view of the real-world environment, C) the physical object being a display showing media content in the view of the real-world environment, D) identifying that a gaze, of the user of the artificial reality system, has dwelt on the identified physical object for a threshold period of time, or E) any combination thereof;
identifying a second position at which the virtual object will not occlude the identified physical object; and
positioning the virtual object to the second position, in the artificial reality environment, rendered as overlaid onto the view of the real-world environment, such that the virtual object does not occlude the identified physical object.

2. The method of claim 1, wherein the determining the first position for the virtual object is based on a determination of how the virtual object would be leashed to a head of a user of the artificial reality system, such that movement of the virtual object tracks movement of the head of the user originating at the first position.

3. The method of claim 2, wherein the positioning the virtual object to the second position includes releashing the virtual object to the head of the user of the artificial reality system at the second position, such that movement of the virtual object tracks movement of the head of the user originating at the second position.

4. The method of claim 2, wherein the positioning the virtual object to the second position includes unleashing the virtual object from the head of the user of the artificial reality system, such that movement of the virtual object does not track movement of the head of the user.

5. The method of claim 1, wherein the virtual object is nonoverlapping with the physical object on x-, y-, and z-axes at the second position.

6. The method of claim 1, wherein identifying the second position includes identifying a plane in the real-world environment.

7. The method of claim 1, wherein identifying the second position is further based on input from a user of the artificial reality system.

8. A computer-readable storage medium storing instructions, for avoiding occlusion in rendering virtual objects in an artificial reality environment, the instructions, when executed by a computing system, cause the computing system to:
determine a first position for a virtual object, in the artificial reality environment on an artificial reality system, at which to overlay the virtual object on a view of a real-world environment surrounding the artificial reality system;
identify, based on an avoidance trigger determined by the artificial reality system, a physical object, in the real-world environment, that is or will be occluded by the virtual object at the first position in the artificial reality environment;
identify a second position at which the virtual object will not occlude the identified physical object; and
position the virtual object to the second position, in the artificial reality environment, and overlaid onto the view of the real-world environment, such that the virtual object does not occlude the identified physical object.

9. The computer-readable storage medium of claim 8, wherein the determined avoidance trigger includes the physical object being a face of an other user in the view of the real-world environment.

10. The computer-readable storage medium of claim 8, wherein the determined avoidance trigger includes the physical object being a display showing media content in the view of the real-world environment.

11. The computer-readable storage medium of claim 8, wherein the determined avoidance trigger includes an activity related to the physical object being performed by a user of the artificial reality system.

12. The computer-readable storage medium of claim 8, wherein the determined avoidance trigger includes identifying that a gaze, of the user of the artificial reality system, has dwelt on the identified physical object for a threshold period of time.

13. The computer-readable storage medium of claim 8, wherein the virtual object is nonoverlapping with the physical object on x-, y-, and z-axes at the second position.

14. The computer-readable storage medium of claim 8, wherein identifying the second position includes identifying a plane in the real-world environment.

15. The computer-readable storage medium of claim 8, wherein identifying the second position is further based on input from a user of the artificial reality system.

16. A computing system for avoiding occlusion in rendering virtual objects in an artificial reality environment, the computing system comprising:
one or more processors; and
one or more memories storing instructions that, when executed by the one or more processors, cause the computing system to:
determine a first position for a virtual object, in the artificial reality environment on an artificial reality system, at which to overlay the virtual object on a view of a real-world environment surrounding the artificial reality system;
identify, based on a determined avoidance trigger, a physical object, in the real-world environment, that is or will be occluded by the virtual object at the first position in the artificial reality environment,
identify a second position at which the virtual object will not occlude the identified physical object; and
position the virtual object to the second position, in the artificial reality environment, and overlaid onto the view of the real-world environment, such that the virtual object does not occlude the identified physical object.

17. The computing system of claim 16, wherein the determined avoidance trigger includes one or more of A) an activity related to the physical object being performed by a user of the artificial reality system, B) the physical object being a face of an other user in the view of the real-world environment, C) the physical object being a display showing media content in the view of the real-world environment, D) identifying that a gaze, of the user of the artificial reality system, has dwelt on the identified physical object for a threshold period of time, or E) any combination thereof.

18. The computing system of claim 16, wherein the determining the first position for the virtual object is based on a determination of how the virtual object would be leashed to a head of a user of the artificial reality system, such that movement of the virtual object tracks movement of the head of the user originating at the first position.

19. The computing system of claim 18, wherein the positioning the virtual object to the second position includes releashing the virtual object to the head of the user of the artificial reality system at the second position, such that movement of the virtual object tracks movement of the head of the user originating at the second position.

20. The computing system of claim 18, wherein the positioning the virtual object to the second position includes unleashing the virtual object from the head of the user of the artificial reality system, such that movement of the virtual object does not track movement of the head of the user.
